(19) United States
(12) Patent Application Publication
(10) Pub. No.: US 2016/0162727 A1
(43) Pub. Date: Jun. 9, 2016

(54) ELECTRONIC DEVICE AND EYE-DAMAGE REDUCTION METHOD OF THE ELECTRONIC DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: SHUANG HU, Shenzhen (CN); CHIH-SAN CHIANG, New Taipei (TW); LING-JUAN JIANG, Shenzhen (CN); HUA-DONG CHENG, Shenzhen (CN)

(21) Appl. No.: 14/695,717

(22) Filed: Apr. 24, 2015

(30) Foreign Application Priority Data
Dec. 5, 2014 (CN) 201410736184.8

(51) Int. Cl. G06K 9/00; G06F 3/01; G06F 3/00

(52) U.S. Cl. CPC G06K 9/00255; G06F 3/005; G06F 3/013

(57) ABSTRACT

In a method for reducing eye damage, caused by watching a display screen, executed in an electronic device, a start time of eye exposure to the display screen is set. At least one image of an object in front of the display screen is captured using an image capturing device. If there is a face region and an eye region of a person in the image, a period of time that the person continuously views the display screen is calculated. If the period of time exceeds a preset time, a message to take a break is issued.

### CROSS-REFERENCE TO RELATED APPLICATIONS

This application claims priority to Chinese Patent Application No. 201410736184.8 filed on Dec. 5, 2014, the contents of which are incorporated by reference herein.

### FIELD

The subject matter herein generally relates to ergonomics and health protection technology, and particularly to an electronic device and an eye-damage reduction method of the electronic device.

### BACKGROUND

With the popularity of electronic devices (e.g., smart phones), users spend more and more time watching screens of the electronic devices, which may result in eye strain and even decreased vision.

### BRIEF DESCRIPTION OF THE DRAWINGS

Implementations of the present technology will now be described, by way of example only, with reference to the attached figures.

FIG. 1 is a block diagram of one example embodiment of a hardware environment for executing an eye-damage reduction system.

FIG. 2 is a block diagram of one example embodiment of function modules of the eye-damage reduction system in FIG. 1.

FIG. 3 is a flowchart of one example embodiment of an eye-damage reduction method.

FIG. 4 illustrates one example embodiment of determining an eye detection region from a face region.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

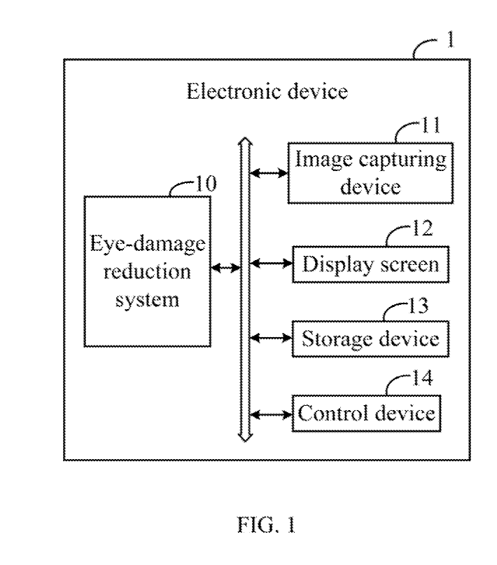

FIG. 1 is a block diagram of one example embodiment of a hardware environment for executing an eye-damage reduction system 10. The eye-damage reduction system 10 is installed in and run by an electronic device 1. The electronic device 1 can include an image capturing device 11, a display screen 12, a storage device 13, and at least one control device 14.

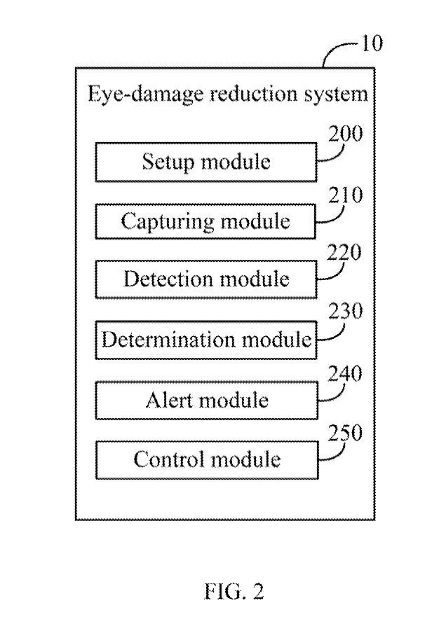

The eye-damage reduction system 10 can include a plurality of function modules (shown in FIG. 2) that monitor the amount of time that a person continuously views the display screen 12, and issue alerts to remind the person to take a break.

The image capturing device 11 is configured to capture images of an object in front of the display screen 12. The image capturing device 11 can be a front-facing camera of the electronic device 1, or a camera device at the front of the electronic device 1.

The storage device 13 can include some type(s) of non-transitory computer-readable storage medium such as, for example, a hard disk drive, a compact disc, a digital video disc, or a tape drive. The storage device 13 stores the computerized codes of the function modules of the eye-damage reduction system 10.

The control device 14 can be a processor, an application-specific integrated circuit (ASIC), or a field programmable gate array (FPGA), for example. The control device 14 can execute computerized codes of the function modules of the eye-damage reduction system 10 to realize the functions of the electronic device 1.

FIG. 2 is a block diagram of one embodiment of function modules of the eye-damage reduction system 10. The function modules can include, but are not limited to, a setup module 200, a capturing module 210, a detection module 220, a determination module 230, an alert module 240, and a control module 250. The function modules 200-250 can include computerized codes in the form of one or more programs, which provide at least the functions of the eye-damage reduction system 10.

The setup module 200 is configured to set a start time of eye exposure to a display screen. For example, the setup module 200 sets the start time of eye exposure as a startup time of the electronic device 1.

The capturing module 210 is configured to control the image capturing device 11 to capture at least one image of an object in front of the display screen 12. In one embodiment, the capturing module 210 captures images at a predetermined frequency. For example, the capturing module 210 can capture a specified number of images each time of capture.

The detection module 220 is configured to detect whether there is a face region and an eye region of a person in the image. In one embodiment, the detection module 220 detects the face region from the image using a face detection algorithm based on skin color, and detects the eye region from the face region.

In one embodiment, the image captured by the image capturing device 11 is an RGB (red, green, blue) image. The detection module 220 obtains an HSV (hue, saturation, value) image corresponding to the RGB image using the following formulas:

$${H}^{′} = {cos}^{- 1} \{ \frac{0.5 \times [ ( R - G ) + ( R - B ) ]}{\sqrt{{( R - G )}^{2} + ( R - B ) \times ( G - B )}} \} , \\ H = \{ \begin{matrix}{H}^{′} ( B \leq G ) \\ 360 ° - {H}^{′} ( B > G )\end{matrix} , \\ S = \frac{Max ( R , G , B ) - Min ( R , G , B )}{Max ( R , G , B )} , \\ V = \frac{Max ( R , G , B )}{255} ,$$

where H, S, and V are respectively hue, saturation, and value of the HSV image.

The detection module 220 determines the face region in the image as follows:

R>G&&|R−G|≧11,

340≦H≦359∥0≦H≦50,

0.12≦S≦0.7 & &0.3≦V≦1.0.

A ratio of width to height of a human face is between about 0.8 and 1.4. Accordingly, the detection module 220 can determine a boundary of the face region as follows:

$${h}^{′} = \{ \begin{matrix}1.25 w & h ∉ [ 0.8 w , 1.4 w ] \\ h & h ∈ [ 0.8 w , 1.4 w ]\end{matrix} ,$$

where h and w are respectively a height and a width of the face region.

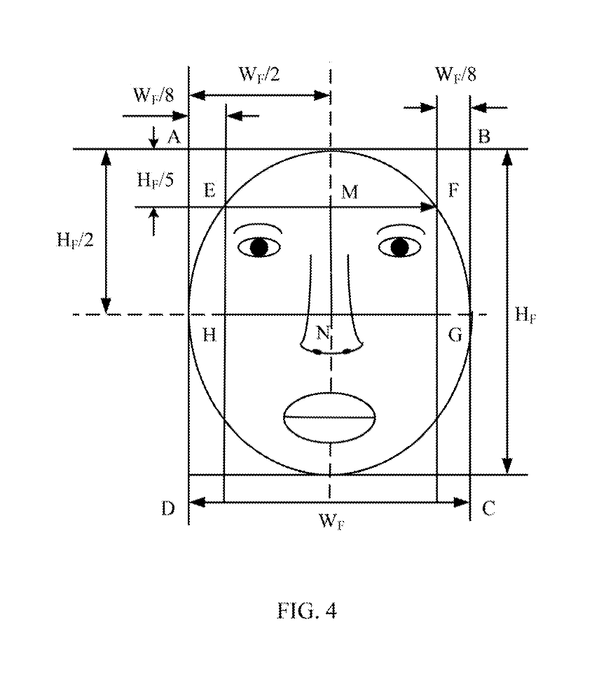

The detection module 220 can determine an eye detection region containing the eye region from the face region, and detect the eye region from the eye detection region. FIG. 4 illustrates one example embodiment of determining the eye detection region from the face region. A height and a width of the eye detection region are respectively denoted as H_{F} and W_{F}. As illustrated by FIG. 4, the eye detection region can be a rectangle EFGH.

The detection module 220 can detect boundaries of an eye from the eye detection region using a Sobel operator. The Sobel operator can be represented as follows:

$${G}_{x} = [ \begin{matrix}1 & 2 & 1 \\ 0 & 0 & 0 \\ - 1 & - 2 & - 1\end{matrix} ] , {G}_{y} = [ \begin{matrix}1 & 0 & - 1 \\ 2 & 0 & - 2 \\ 1 & 0 & - 1\end{matrix} ] .$$

Original boundary values of the eye boundaries can be obtained by following steps:

(1) setting gray values of pixels at edges of the eye detection region as 0,

(2) calculating a horizontal edge value and a vertical edge value of each pixel in the eye detection region as follows:

$${B}_{x} ( i , j ) = {\sum }_{mn - 1}^{1} {\sum }_{mn - 1}^{1} A ( i + m , j + n ) \cdot {G}_{x} ( m , n ) , \\ {B}_{y} ( i , j ) = {\sum }_{mn - 1}^{1} {\sum }_{mn - 1}^{1} A ( i + m , j + n ) \cdot {G}_{y} ( m , n ) ,$$

(3) comparing an absolute value of Bₓ(i,j) and an absolute value of B_{y}(i,j), if |Bₓ(i,j)|>=|B_{y}(i,j)|, B*(i,j)=|Bₓ(i,j)|, otherwise B*(i,j)=|B_{y}(i,j)|.

The detection module 220 can determine the eye region as follows:

$$B * ( i , j ) = \{ \begin{matrix}1 & B ( i , j ) \geq T \\ 0 & B ( i , j ) < T\end{matrix} ,$$

where B*(i,j)=1 denotes pixels in the eye region, and B*(i,j)=0 denotes pixels out of the eye region. T is a preset threshold.

The determination module 230 is configured to calculate a period of time that the person continuously views the display screen 12 if there is the face region and the eye region in the image. The determination module 230 is configured to determine whether the period of time exceeds a preset time (e.g., 40 minutes).

The alert module 240 is configured to issue an alert to remind the person to take a break if the period of time exceeds the preset time. The alert module 240 can issue a text message or a voice message. The text message can be displayed on the display screen 12, and the voice message can be output by an audio device (e.g., a speaker or an earphone) of the electronic device 1.

The control module 250 is configured to control the electronic device 1 to enter a standby state if there is no face region or eye region in the image. The control module 250 can be further configured to record a standby start time when the electronic device 1 enters the standby state and a wakening time when the electronic device 1 is woken up, calculate a difference between the wakening time and the standby start time, and determine whether or not the difference is less than a specified time for rest (e.g., 5 minutes).

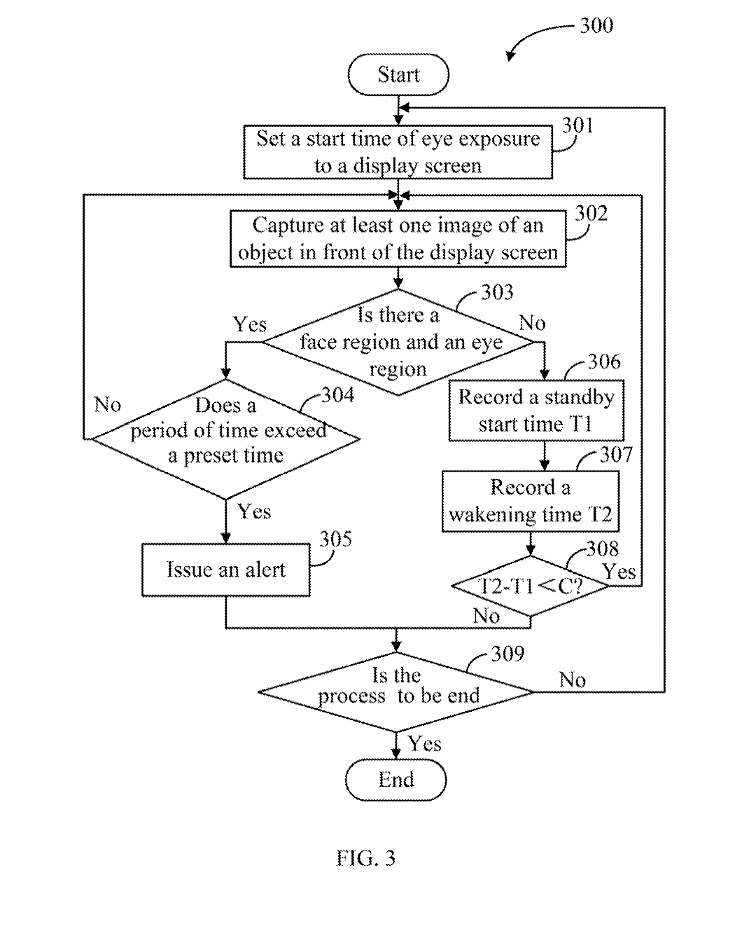

FIG. 3 is a flowchart of one example embodiment of an eye-damage reduction method. In the embodiment, the method is performed by execution of computer-readable software program codes or instructions by a control device, such as at least one processor of an electronic device. The electronic device includes an image capturing device and a display screen.

Referring to FIG. 3, a flowchart is presented in accordance with an example embodiment. The method 300 is provided by way of example, as there are a variety of ways to carry out the method. The method 300 described below can be carried out using the configurations illustrated in FIGS. 1-2, for example, and various elements of these figures are referenced in explaining method 300. Each block shown in FIG. 3 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The method 300 can begin at block 301.

At block 301, a setup module sets a start time of eye exposure to a display screen. For example, the setup module sets the start time of eye exposure as a startup time of the electronic device.

At block 302, a capturing module controls the image capturing device to capture at least one image of an object in front of the display screen. In one embodiment, the capturing module captures images at a predetermined frequency. For example, the capturing module can capture a specified number of images each time of capture.

At block 303, a detection module detects whether there is a face region and an eye region of a person in the image. In one embodiment, the detection module detects the face region from the image using a face detection algorithm based on skin color, and detects the eye region from the face region.

If there is the face region and the eye region in the image, at block 304, a determination module calculates a period of time that the person continuously views the display screen, and determines whether the period of time exceeds a preset time (e.g., 40 minutes). If the period of time does not exceed the preset time, the flow returns to block 302.

If the period of time exceeds the preset time, at block 305, an alert module issue an alert to remind the person to take a break. The alert module can issue a text message or a voice message.

If there is no face region or eye region in the image, at block 306, a control module controls the electronic device to enter a standby state, and records a standby start time (denoted as “T1”) when the electronic device enters the standby state.

At block 307, the control module records a wakening time (denoted as “T2”) when the electronic device is woken up.

At block 308, the control module calculates a difference between the wakening time and the standby start time, and determines whether the difference is less than a specified time for rest (e.g., 5 minutes), denoted as T2−T1<C in block 308 of FIG. 3. If the difference is less than the specified time for rest, the flow returns to block 302.

If the difference is not less than the specified time for rest, at block 309, the control module determines whether to end the eye-damage reduction process. If the eye-damage reduction process is not to be ended, the flow returns to block 301 and the setup module resets the start time of eye exposure. Otherwise, the flow ends.

In another embodiment, the flow ends if there is no face region or eye region in the image.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size, and arrangement of parts within the principles of the present disclosure, up to and including the full extent established by the broad general meaning of the terms used in the claims.

What is claimed is:

1. An eye-damage reduction method being executable by at least one control device of an electronic device, the electronic device comprising an image capturing device and a display screen, the method comprising:
(a) setting a start time of eye exposure to the display screen;
(b) controlling the image capturing device to capture at least one image of an object in front of the display screen;
(c) detecting within the captured image, the presence of a face region and an eye region within the face region;
(d) calculating a period of time that a person continuously views the display screen upon condition that the eye region is present in the image, and determining that the calculated period of time exceeds a preset time; and
(e) issuing an alert.

2. The method according to claim 1, further comprising:
controlling the electronic device to enter a standby state upon condition that there is no face region or eye region in the image.

3. The method according to claim 2, further comprising:
recording a standby start time when the electronic device enters the standby state and a wakening time when the electronic device is woken up, calculating a difference between the wakening time and the standby start time, and returning to (b) upon condition that the difference is less than a specified time for rest.

4. The method according to claim 1, wherein the face region is detected from the image using a face detection algorithm based on skin color.

5. An electronic device comprising:
an image capturing device;
a display screen;
a control device; and
a storage device storing one or more programs which when executed by the control device, causes the control device to perform operations comprising:
setting a start time of eye exposure to the display screen;
controlling the image capturing device to capture at least one image of an object in front of the display screen;
detecting within the captured image, the presence of a face region and an eye region within the face region;
calculating a period of time that a person continuously views the display screen upon condition that the eye region is present in the image, and determining that the calculated period of time exceeds a preset time; and
issuing an alert.

6. The electronic device according to claim 5, wherein the operations further comprise:
controlling the electronic device to enter a standby state upon condition that there is no face region or eye region in the image.

7. The electronic device according to claim 6, wherein the operations further comprise:
recording a standby start time when the electronic device enters the standby state and a wakening time when the electronic device is woken up, calculating a difference between the wakening time and the standby start time, and determining whether the difference is less than a specified time for rest.

8. The electronic device according to claim 5, wherein the face region is detected from the image using a face detection algorithm based on skin color.

9. A non-transitory storage medium having stored thereon instructions that, when executed by a control device of an electronic device, causes the control device to perform an eye-damage reduction method, the electronic device comprising an image capturing device and a display screen, the method comprising:
(a) setting a start time of eye exposure to the display screen;
(b) controlling the image capturing device to capture at least one image of an object in front of the display screen;
(c) detecting within the captured image, the presence of a face region and an eye region within the face region;
(d) calculating a period of time that a person continuously views the display screen upon condition that the eye region is present in the image, and determining that the calculated period of time exceeds a preset time; and
(e) issuing an alert.

10. The non-transitory storage medium according to claim 9, wherein the method further comprises:
controlling the electronic device to enter a standby state upon condition that there is no face region or eye region in the image.

11. The non-transitory storage medium according to claim 10, wherein the method further comprises:
recording a standby start time when the electronic device enters the standby state and a wakening time when the electronic device is woken up, calculating a difference between the wakening time and the standby start time, and returning to (b) upon condition that the difference is less than a specified time for rest.

12. The non-transitory storage medium according to claim 9, wherein the face region is detected from the image using a face detection algorithm based on skin color.
